(19) United States
(12) Patent Application Publication
(10) Pub. No.: US 2018/0320768 A1
(43) Pub. Date: Nov. 8, 2018

(54) MULTI-MODE CONTINUOUSLY-VARIABLE TRANSMISSION

(71) Applicant: GM GLOBAL TECHNOLOGY OPERATIONS LLC, Detroit, MI (US)

(72) Inventors: Chengwu Duan, Shanghai (CN); Robert J. Gonzales, Clarkston, MI (US); Ying Huang, Shanghai (CN); Jian Yao, Shanghai (CN)

(73) Assignee: GM GLOBAL TECHNOLOGY OPERATIONS LLC, Detroit, MI (US)

(21) Appl. No.: 15/587,796

(22) Filed: May 5, 2017

(51) Int. Cl. F16H 37/02; F16H 37/06; F16H 9/16

(52) U.S. Cl. CPC F16H 37/021; F16H 2200/0008; F16H 9/16; F16H 37/06

(57) ABSTRACT

A multiple-mode continuously-variable transmission (CVT) assembly for connecting to an external power-source is disclosed. The assembly includes a continuously-variable speed-ratio unit having an input member and a multiple fixed speed-ratio unit having another input member, wherein the multiple fixed speed-ratio unit is operatively connected to the continuously-variable speed-ratio unit. The assembly also includes a first torque-transmitting device operatively connected to each of the input members of the continuously-variable speed-ratio unit and the multiple fixed speed-ratio unit. The first torque-transmitting device is configured to receive an input torque from the external power-source. The assembly also includes an output member operatively connected to each of the continuously-variable speed-ratio unit and the multiple fixed speed-ratio unit and configured to carry an output torque from the assembly. A motor vehicle having such a multiple-mode CVT assembly is also disclosed.

### INTRODUCTION

The disclosure relates to a multiple-mode continuously-variable transmission (CVT) for a motor vehicle.

A majority of modern motor vehicles use a transmission to enable a power-source, such as an internal combustion engine, to power the vehicle across a wide range of road speeds with desired acceleration and efficiency. Frequently such transmissions are automatic or self-shifting. Such transmissions can automatically change gear ratios as the vehicle moves, freeing the driver of the vehicle from having to shift gears manually. Like other transmission systems on vehicles, a transmission allows an internal combustion engine, best suited to run at a relatively high rotational speed, to provide a range of speed and torque outputs necessary for driving the vehicle in various conditions. A transmission can offer a fixed number of gear ratios or be configured as a continuously-variable transmission (CVT) that can change steplessly through a continuous range of effective gear ratios.

In general, a CVT can change through an infinite number of effective gear ratios between a maximum gear ratio and a minimum gear ratio. A typical continuously variable transmission includes two adjustable pulleys, each having two sheaves. A belt or any suitable endless rotatable device, such as a continuous loop cable or chain, typically runs between the two pulleys, with the two sheaves of each of the pulleys sandwiching the belt therebetween. Frictional engagement between the sheaves of each pulley and the belt couples the belt to each of the pulleys to transfer a torque from one pulley to the other. One of the pulleys may function as a drive pulley so that the other pulley can be driven by the drive pulley via the belt. The gear ratio is the ratio of the torque of the driven pulley to the torque of the drive pulley. The gear ratio may be changed by moving the two sheaves of one of the pulleys closer together and the two sheaves of the other pulley farther apart, causing the belt to ride higher or lower on the respective pulley.

### SUMMARY

A multiple-mode continuously-variable transmission (CVT) assembly for connecting to an external power-source is disclosed herein. The assembly includes a continuously-variable speed-ratio unit having an input member and a multiple fixed speed-ratio unit having another input member, wherein the multiple fixed speed-ratio unit is operatively connected the continuously-variable speed-ratio unit. The assembly also includes a first torque-transmitting device operatively connected to each of the input members of the continuously-variable speed-ratio unit and the multiple fixed speed-ratio unit. The first torque-transmitting device is configured to receive torque from the external power-source. The assembly also includes an output member operatively connected to each of the continuously-variable speed-ratio unit and the multiple fixed speed-ratio unit and configured to carry an output torque from the assembly.

The multiple-mode CVT assembly may also include an assembly housing configured to retain each of the continuously-variable speed-ratio unit, the multiple fixed speed-ratio unit, and the first torque-transmitting device.

The first torque-transmitting device, the continuously-variable speed-ratio unit, and the multiple fixed speed-ratio unit may be connected in series. In such an embodiment, the first torque-transmitting device may be directly connected to the input member of the continuously-variable speed-ratio unit and the continuously-variable speed-ratio unit may be directly connected to the input member of the multiple fixed speed-ratio unit. Additionally, the multiple fixed speed-ratio unit may be directly connected to the assembly output member.

Alternatively, the continuously-variable speed-ratio unit and the multiple fixed speed-ratio unit may be connected to the first torque-transmitting device in parallel. In such an embodiment, the continuously-variable speed-ratio unit and the multiple fixed speed-ratio unit may be configured to selectively transmit the power-source torque to the assembly output member.

The multiple-mode CVT assembly may also include a second torque-transmitting device arranged between the first torque-transmitting device and each of the continuously-variable speed-ratio unit and the multiple fixed speed-ratio unit. In such a case, the second torque-transmitting device may be configured to selectively connect the first torque-transmitting device to the respective input member of one of the continuously-variable speed-ratio unit and the multiple fixed speed-ratio unit.

The assembly housing may be additionally configured to retain the second torque-transmitting device.

The continuously-variable speed-ratio unit may be configured to transmit the torque from the power-source to the assembly output member in direct drive through overdrive modes. Furthermore, the multiple fixed speed-ratio unit may be configured to transmit the power-source torque to the assembly output member in underdrive through direct drive modes.

The continuously-variable speed-ratio unit may be configured as a continuously-variable transmission (CVT). Such a CVT may include a variable diameter input pulley and a variable diameter output pulley connected via a chain.

The multiple fixed speed-ratio unit may be configured as a multi-speed automatic gearbox.

The first torque-transmitting device may be configured as a fluid coupling, i.e., a torque converter, or a friction plate clutch.

A motor vehicle having such a multiple-mode CVT assembly connected to an internal combustion engine is also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic illustration of a vehicle employing a power-source connected to a multiple-mode continuously-variable transmission (CVT) assembly, according to the disclosure.

FIG. 2 is a schematic illustration of one embodiment of the multiple-mode CVT assembly shown in FIG. 1.

FIG. 3 is a schematic illustration of another embodiment of the multiple-mode CVT assembly shown in FIG. 1.

### DETAILED DESCRIPTION

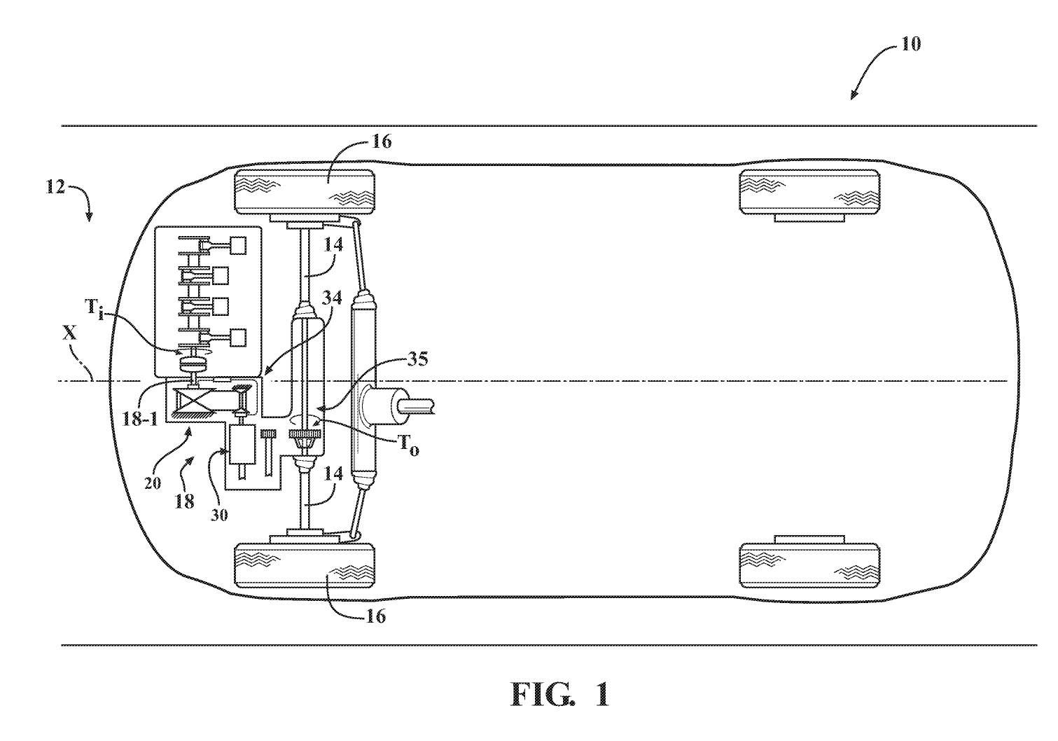

Referring to the drawings in which like elements are identified with identical numerals throughout, FIG. 1 illustrates a motor vehicle 10 having a power-source 12, shown as an internal combustion engine. It is noted, however, that the power-source 12 may be an appropriate power-source configured to generate a power-source torque Tᵢ for driving the vehicle 10, such as an electric motor-generator or a fuel cell. The power-source 12 is operatively connected to one or more drive axles 14 that include respective sets of driven wheels 16. The motor vehicle 10 may include, without being limited to, a commercial vehicle, industrial vehicle, passenger vehicle, aircraft, watercraft, train or the like. As shown, the vehicle 10 is generally arranged along a longitudinal vehicle axis X.

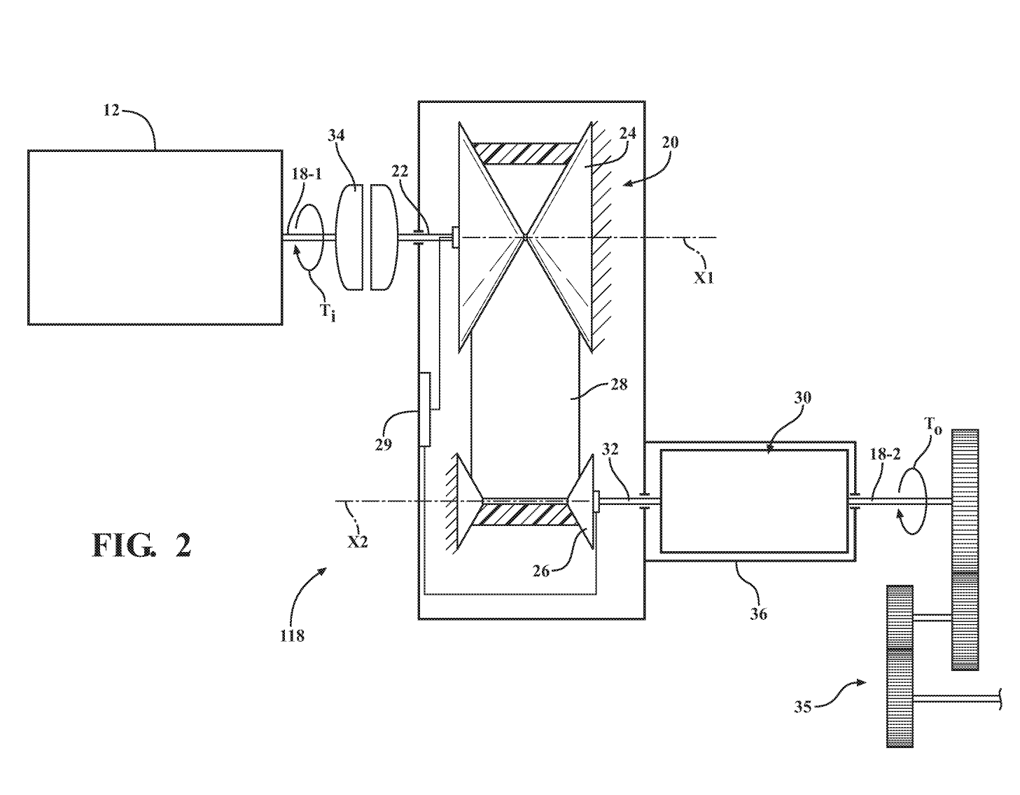

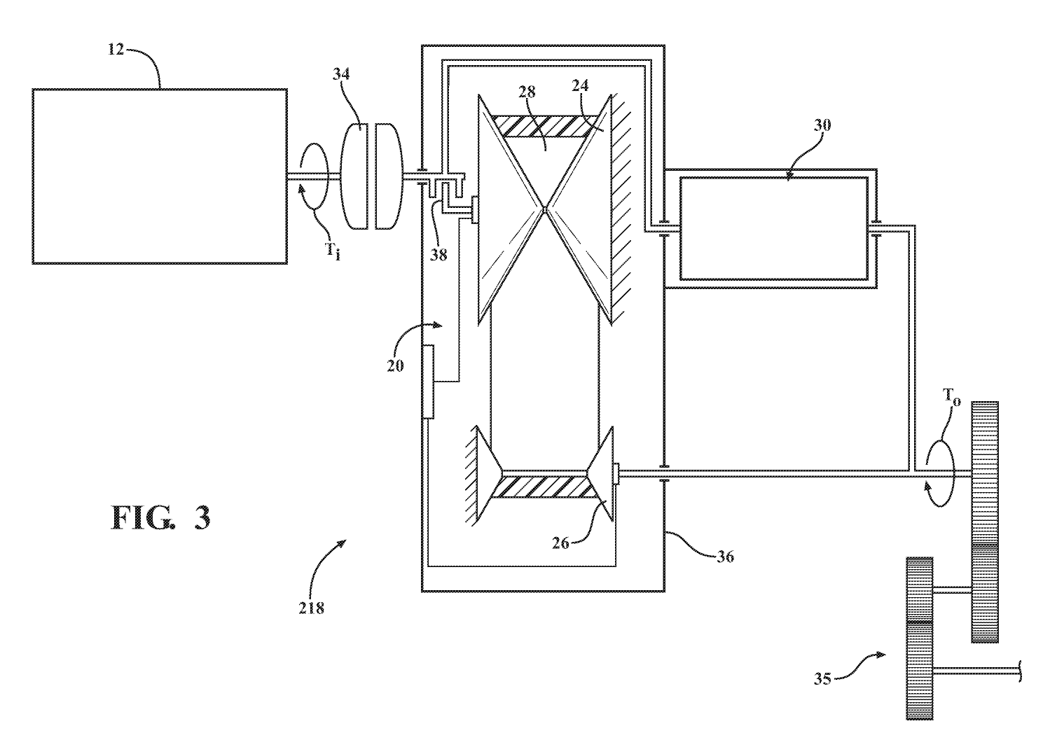

The vehicle 10 also includes a multiple-mode continuously-variable transmission (CVT) assembly 18 for connecting the power-source 12 to the drive axle(s) 14. The power-source is mounted in the vehicle 10 externally with respect to the multiple-mode continuously-variable transmission (CVT) assembly 18, i.e., the multiple-mode continuously-variable transmission (CVT) assembly 18 may be operatively connected to the power-source 12 and be appropriately fastened thereto. The CVT assembly 18 includes an assembly input member 18-1 configured to receive the power-source torque Tᵢ. The CVT assembly 18 also includes a continuously-variable speed-ratio torque transmitting unit 20. The continuously-variable torque transmitting unit 20 provides a continuous range of effective speed ratios between the input and output members. As shown in FIGS. 2-3, the continuously-variable torque transmitting unit 20 may be configured as a variable-diameter pulley system, otherwise known as a “Reeves drive”. The continuously-variable torque transmitting unit 20 includes an input member 22 configured to receive the power-source torque Tᵢ. As shown, the variable-diameter pulley system embodiment of the continuously-variable torque transmitting unit 20 employs a variable-diameter input pulley 24 and a variable-diameter output pulley 26, each split perpendicular to its respective axis of rotation X1 and X2, and connected via a continuous torque-transmitting element 28 running therebetween. Specifically, the torque-transmitting element 28 may be a V-belt or a chain. The input member 22 is operatively connected to the input pulley 24. An actuator 29, such as a fluid pump or an electric motor, may be employed to vary the effective diameters of the input and output pulleys 24, 26.

As understood by those skilled in the art, in the variable-diameter pulley system, the speed ratio of the continuously-variable torque transmitting unit 20 is changed by moving the two sheaves of one of the input and output pulleys 24, 26 closer together and the two sheaves of the other pulley farther apart. The V-shaped cross section of the torque-transmitting element 28 causes the element to ride higher on one of the pulleys 24, 26 and lower on the other. Such movement of the respective sheaves of the pulleys 24, 26 changes the effective diameters of both pulleys, and, in turn, changes the overall speed ratio of the torque transmitting unit 20. Because the distance between the respective pulleys 24, 26 and the length of the torque-transmitting element 28 does not change, generally, both pulleys are adjusted simultaneously.

The CVT assembly 18 also includes a stepped multiple fixed speed-ratio unit 30. The multiple fixed speed-ratio unit 30 may include an appropriate gear-train (not shown), which may be configured as a parallel-shaft manual or automatically shiftable gear-train, or an epicyclic automatically shiftable multi-speed gear-train, each providing a discrete number of speed-ratios as understood by those skilled in the art. The multiple fixed speed-ratio unit 30 is operatively connected to the continuously-variable speed-ratio unit 20. Specifically, as shown in FIGS. 2-3, depending on the specific embodiment of the CVT assembly 18 to be discussed in detail below, the input member 32 of the multiple fixed speed-ratio unit 30 may be connected either directly to the continuously-variable torque transmitting unit 20 or to the power-source 12.

As shown in FIGS. 1-3, the CVT assembly 18 additionally includes a first torque-transmitting device 34 operatively connected to each of the input member 22 of the continuously-variable speed-ratio unit 20 and an input member 32 of the multiple fixed speed-ratio unit 30 and configured to receive the power-source torque Tᵢ. The first torque-transmitting device 34 may be configured as either a fluid coupling, i.e., a torque converter configured to multiply the power-source torque or a friction clutch, such as a dry or wet friction plate assembly. The CVT assembly 18 also includes an assembly output member 18-2 operatively connected to each of the continuously-variable speed-ratio unit 20 and the multiple fixed speed-ratio unit 30. The assembly output member 18-2 is configured to carry an output torque To from the assembly to the drive axle(s) 14, such as through a final drive assembly 35. The multiple-mode CVT assembly 18 additionally includes an assembly housing 36 configured to retain each of the continuously-variable speed-ratio unit 20, the multiple fixed speed-ratio unit 30, and the first torque-transmitting device 34.

FIG. 2 illustrates a multiple-mode CVT assembly 118, which is a specific embodiment of the multiple-mode CVT assembly 18 shown in FIG. 1. In the multiple-mode CVT assembly 118, the first torque-transmitting device 34, the continuously-variable speed-ratio unit 20, and the multiple fixed speed-ratio unit 30 are all connected in series. The first torque-transmitting device 34 is directly connected to the input member 22 of the continuously-variable speed-ratio unit. The continuously-variable speed-ratio unit 20 is directly connected to the input member 32 of the multiple fixed speed-ratio unit 30. Additionally, the multiple fixed speed-ratio unit 30 is directly connected to the assembly output member 18-2. During operation of the multiple-mode CVT assembly 118, the power-source torque Tᵢ received by the first torque-transmitting device 34 is transmitted to the input member 22 of the continuously-variable speed-ratio unit 20 and from the continuously-variable speed-ratio unit the engine torque is transmitted to the input member 32 of the multiple fixed speed-ratio unit 30. The output torque Tₒ is then transmitted to the assembly output member 18-2 from the multiple fixed speed-ratio unit 30.

FIG. 3 illustrates a multiple-mode CVT assembly 218, which is a specific embodiment of the multiple-mode CVT assembly 18 shown in FIG. 1. In the multiple-mode CVT assembly 218, the continuously-variable speed-ratio unit 20 and the multiple fixed speed-ratio unit 30 are connected to the first torque-transmitting device 34 in parallel. The continuously-variable speed-ratio unit 20 and the multiple fixed speed-ratio unit 30 are configured to selectively transmit the power-source torque Tᵢ to the assembly output member 18-2. During operation of the multiple-mode CVT assembly 118, the power-source torque Tᵢ, after being received by the first torque-transmitting device 34, is selectively transmitted to either the input member 22 of the continuously-variable speed-ratio unit 20 or to the input member 32 of the multiple fixed speed-ratio unit 30. Additionally, the output torque Tₒ is transmitted to the output member 18-2 either from the continuously-variable speed-ratio unit 20 or from the multiple fixed speed-ratio unit 30.

As shown in FIG. 3, the embodiment of the multiple-mode CVT assembly 218 may additionally include a second torque-transmitting device 38. As shown, the second torque-transmitting device 38 is arranged between the first torque-transmitting device 34 and each of the continuously-variable speed-ratio unit 20 and the multiple fixed speed-ratio unit 30. In other words, the second torque-transmitting device 38 is positioned within the multiple-mode CVT assembly 218 in the flow of power-source torque Tᵢ from the power-source 12 toward the drive axle(s) 14, downstream of the first torque-transmitting device 34 and upstream of each of the continuously-variable speed-ratio unit 20 and the multiple fixed speed-ratio unit 30. Operatively, the second torque-transmitting device 38 is configured to selectively connect the first torque-transmitting device 34 either to the input member 22 of the continuously-variable speed-ratio unit 20 or to the input member 32 of the multiple fixed speed-ratio unit 30.

In the multiple-mode CVT assembly 218, the assembly housing 36 may be additionally configured to retain the second torque-transmitting device 38. The continuously-variable speed-ratio unit 20 may be configured to transmit the power-source torque Tᵢ to the assembly output member 18-2 in direct drive through overdrive modes, such as at elevated road speeds of the vehicle 10. In other words, the continuously-variable speed-ratio unit 20 may be configured to operate in modes where the ratio of the power-source torque Tᵢ to the output torque Tₒ is smaller than 1:1 and, conversely, the ratio of rotational input speed from the power-source 12 to rotational speed of the assembly output member 18-2 is greater than 1:1. On the other hand, the multiple fixed speed-ratio unit 30 may be configured to transmit the power-source torque Tᵢ to the assembly output member 18-2 in underdrive through direct drive modes, such as during launch of the vehicle 10 from rest and to enable vehicle stop/start operation. In other words, the multiple fixed speed-ratio unit 30 may be configured to operate in modes where the ratio of the power-source torque Tᵢ to the output torque Tₒ is greater than 1:1 and, conversely, the ratio of rotational input speed from the power-source 12 to rotational speed of the assembly output member 18-2 is smaller than 1:1.

Overall, in the multiple-mode CVT assemblies 118 and 218, the continuously-variable speed-ratio unit 20 and the multiple fixed speed-ratio unit 30 are employed to facilitate distinct, substantially non-overlapping, speed-ratios and road-speed ranges. Therefore, the continuously-variable speed-ratio unit 20 is configured as an “asymmetric” CVT, wherein the term “asymmetric” is employed herein to denote that the continuously-variable speed-ratio unit is only used in a limited range of speed-ratios, such as overdrive numerical ratios. Accordingly, the multiple fixed speed-ratio unit 30 is configured to transmit the power-source torque Tᵢ in numerically higher ratios to permit effective launch of the vehicle 10 from rest and propulsion at lower road speeds. Furthermore, in the embodiments of the multiple-mode CVT assemblies 118 and 218 described above, the multiple-mode CVT assembly is intended to arrange the continuously-variable speed-ratio unit 20 and the multiple fixed speed-ratio unit 30 such that the continuously-variable speed-ratio unit transmits the power-source torque Tᵢ in lower, such as overdrive numerical ratios, and higher road speeds of the vehicle 10. Such arrangement of either of the CVT assemblies 118 and 218 enable enhanced efficiency of the particular CVT assembly and may also facilitate usage of a reduced power-consumption actuator 29.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A multiple-mode continuously-variable transmission (CVT) assembly for transmitting a torque from an external power-source, comprising:
a continuously-variable speed-ratio unit having an input member;
a multiple fixed speed-ratio unit having another input member, wherein the multiple fixed speed-ratio unit is operatively connected to the continuously-variable speed-ratio unit;
a first torque-transmitting device operatively connected to each of the input members of the continuously-variable speed-ratio unit and the multiple fixed speed-ratio unit and configured to receive the torque from the external power-source; and
an assembly output member operatively connected to each of the continuously-variable speed-ratio unit and the multiple fixed speed-ratio unit and configured to carry an output torque from the assembly.

2. The multiple-mode CVT assembly according to claim 1, further comprising an assembly housing configured to retain each of the continuously-variable speed-ratio unit, the multiple fixed speed-ratio unit, and the first torque-transmitting device.

3. The multiple-mode CVT assembly according to claim 2, wherein:
the first torque-transmitting device, the continuously-variable speed-ratio unit, and the multiple fixed speed-ratio unit are connected in series;
the first torque-transmitting device is directly connected to the input member of the continuously-variable speed-ratio unit;
the continuously-variable speed-ratio unit is directly connected to the input member of the multiple fixed speed-ratio unit; and
the multiple fixed speed-ratio unit is directly connected to the assembly output member.

4. The multiple-mode CVT assembly according to claim 2, wherein:
the continuously-variable speed-ratio unit and the multiple fixed speed-ratio unit are connected to the first torque-transmitting device in parallel; and
the continuously-variable speed-ratio unit and the multiple fixed speed-ratio unit are configured to selectively transmit the torque from the power-source to the assembly output member.

5. The multiple-mode CVT assembly according to claim 4, further comprising a second torque-transmitting device arranged between the first torque-transmitting device and each of the continuously-variable speed-ratio unit and the multiple fixed speed-ratio unit, wherein the second torque-transmitting device is configured to selectively connect the first torque-transmitting device to the respective input member of one of the continuously-variable speed-ratio unit and the multiple fixed speed-ratio unit.

6. The multiple-mode CVT assembly according to claim 5, wherein the assembly housing is additionally configured to retain the second torque-transmitting device.

7. The multiple-mode CVT assembly according to claim 5, wherein:
the continuously-variable speed-ratio unit is configured to transmit the torque from the power-source to the assembly output member in direct drive through overdrive modes; and
the multiple fixed speed-ratio unit is configured to transmit the torque from the power-source to the assembly output member in underdrive through direct drive modes.

8. The multiple-mode CVT assembly according to claim 1, wherein the continuously-variable speed-ratio unit is configured as a continuously-variable transmission (CVT) including a variable diameter input pulley and a variable diameter output pulley connected via a chain.

9. The multiple-mode CVT assembly according to claim 1, wherein the multiple fixed speed-ratio unit is configured as a multi-speed automatic gearbox.

10. The multiple-mode CVT assembly according to claim 1, wherein the first torque-transmitting device is configured as one of a fluid coupling and a friction plate clutch.

11. A motor vehicle comprising:
an internal combustion engine configured to generate an engine torque;
a drive axle; and
a multiple-mode continuously-variable transmission (CVT) assembly for connecting the internal combustion engine to the drive axle, including:
a continuously-variable speed-ratio unit having an input member;
a multiple fixed speed-ratio unit having another input member, wherein the multiple fixed speed-ratio unit is operatively connected to the continuously-variable speed-ratio unit;
a first torque-transmitting device operatively connected to each of the input members of the continuously-variable speed-ratio unit and the multiple fixed speed-ratio unit and configured to receive the engine torque; and
an assembly output member operatively connected to each of the continuously-variable speed-ratio unit and the multiple fixed speed-ratio unit and configured to carry an output torque from the assembly to the drive axle.

12. The motor vehicle according to claim 11, wherein the multiple-mode CVT assembly additionally includes an assembly housing configured to retain each of the continuously-variable speed-ratio unit, the multiple fixed speed-ratio unit, and the first torque-transmitting device.

13. The motor vehicle according to claim 12, wherein:
the first torque-transmitting device, the continuously-variable speed-ratio unit, and the multiple fixed speed-ratio unit are connected in series;
the first torque-transmitting device is directly connected to the input member of the continuously-variable speed-ratio unit;
the continuously-variable speed-ratio unit is directly connected to the input member of the multiple fixed speed-ratio unit; and
the multiple fixed speed-ratio unit is directly connected to the assembly output member.

14. The motor vehicle according to claim 12, wherein:
the continuously-variable speed-ratio unit and the multiple fixed speed-ratio unit are connected to the first torque-transmitting device in parallel; and
the continuously-variable speed-ratio unit and the multiple fixed speed-ratio unit are configured to selectively transmit the engine torque to the assembly output member.

15. The motor vehicle according to claim 14, wherein:
the multiple-mode CVT assembly additionally includes a second torque-transmitting device arranged between the first torque-transmitting device and each of the continuously-variable speed-ratio unit and the multiple fixed speed-ratio unit; and
the second torque-transmitting device is configured to selectively connect the first torque-transmitting device to the respective input member of one of the continuously-variable speed-ratio unit and the multiple fixed speed-ratio unit.

16. The motor vehicle according to claim 15, wherein the assembly housing is additionally configured to retain the second torque-transmitting device.

17. The motor vehicle according to claim 15, wherein:
the continuously-variable speed-ratio unit is configured to transmit the engine torque to the assembly output member in direct drive through overdrive modes; and
the multiple fixed speed-ratio unit is configured to transmit the engine torque to the assembly output member in underdrive through direct drive modes.

18. The motor vehicle according to claim 11, wherein the continuously-variable speed-ratio unit is configured as a continuously-variable transmission (CVT) including a variable diameter input pulley and a variable diameter output pulley connected via a chain.

19. The motor vehicle according to claim 11, wherein the multiple fixed speed-ratio unit is configured as a multi-speed automatic gearbox.

20. The motor vehicle according to claim 11, wherein the first torque-transmitting device is configured as one of a fluid coupling and a friction plate clutch.
